(19) United States
(12) Patent Application Publication
(10) Pub. No.: US 2018/0075842 A1
(43) Pub. Date: Mar. 15, 2018

(54) REMOTE SPEECH RECOGNITION AT A VEHICLE

(71) Applicant: GM Global Technology Operations LLC, Detroit, MI (US)

(72) Inventors: Xu Fang Zhao, WINDSOR (CA); Gaurav Talwar, NOVI, MI (US)

(21) Appl. No.: 15/265,430

(22) Filed: Sep. 14, 2016

(51) Int. Cl. G10L 15/06; G10L 15/22

(52) U.S. Cl. CPC G10L 15/063; G10L 2015/223; G10L 15/22

(57) ABSTRACT

A system and method of using remote speech recognition at a vehicle includes: receiving speech at the vehicle from a vehicle occupant; determining a wireless quality of service between the vehicle and a speech processing remote facility; transmitting the received speech to the remote speech processing facility when the wireless quality of service is above a threshold; and processing the received speech at the vehicle when the wireless quality of service is below the threshold.

### TECHNICAL FIELD

The present invention relates to speech recognition and, more particularly, to using remote speech recognition in a vehicle.

### BACKGROUND

A variety of vehicle functions may be controlled or services obtained at a vehicle using automatic speech recognition. Vehicles include hardware and software capable of receiving speech from a vehicle occupant, processing that speech to understand speech content, and then carrying out some action based on the speech content. The vehicles can use the hardware and software to process received speech solely at the vehicle. Alternatively, the vehicle can send the received speech as packetized data to a remote facility where the speech recognition processing occurs. The remote facility can then respond to the vehicle with a speech recognition analysis. Performing speech recognition at each location has its advantages and it would be helpful to identify conditions when it is more advantageous to send speech to the remote facility rather than performing speech recognition at the vehicle.

### SUMMARY

According to an embodiment of the invention, there is provided a method of using remote speech recognition at a vehicle. The method includes receiving speech at the vehicle from a vehicle occupant; determining a wireless quality of service between the vehicle and a remote speech processing facility; transmitting the received speech to the remote speech processing facility when the wireless quality of service is above a threshold; and processing the received speech at the vehicle when the wireless quality of service is below the threshold.

According to another embodiment of the invention, there is provided a method of using remote speech recognition at a vehicle. The method includes training an automatic speech recognition (ASR) system with a plurality of remote speech recognition command words; receiving speech at the vehicle from a vehicle occupant; initially processing the received speech using the ASR system; identifying one or more remote speech recognition command words included in the received speech before generating a speech hypothesis; and wirelessly transmitting the received speech to a remote speech processing facility based on the presence of one or more speech recognition command words.

According to another embodiment of the invention, there is provided a method of using remote speech recognition at a vehicle. The method includes receiving speech at the vehicle from a vehicle occupant; determining the quantity of speech received from the vehicle occupant; transmitting the received speech to a remote speech processing facility when the quantity of speech is below a threshold; and processing the received speech at the vehicle when the quantity of speech is above the threshold.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a block diagram depicting an embodiment of an automatic speech recognition (ASR) system;

FIG. 3 is a flow chart of an embodiment of a method of triggering remote speech recognition in a vehicle.

### DETAILED DESCRIPTION OF THE ILLUSTRATED EMBODIMENT(S)

The system and method described below involves receiving speech at a vehicle from a vehicle occupant and performing speech recognition on that speech either at the vehicle or at a remote speech processing facility that wirelessly receives the speech from the vehicle. Depending on a number of factors relating to the content of the speech received or the quality of the wireless communications available at the vehicle, it may be advantageous to process the speech either at the vehicle or the remote facility. For example, the disadvantages of sending speech to a remote facility involve the use fees charged by wireless carrier systems for sending speech from the vehicle to the remote facility. Each time the vehicle sends speech to be analyzed by the remote facility, the vehicle or telematics service provider incurs a charge for doing so. This charge could be based on the length of time needed to send the speech, the amount of data the speech includes, or both. On the other hand, remote facilities that receive speech from the vehicle can maintain more powerful computer processing capabilities drawing on language models that are more sophisticated than what may be available on the vehicle. Vehicle-based speech processing may have its own disadvantages. While recognizing received speech at the vehicle may minimize the fees charged by wireless carrier systems, the vehicle's computer processing capabilities may be less powerful than those available at the remote facility and the vehicle may use simpler language models that may include less content than what may be available at the remote facility, which may mean less accurate results.

Not all speech received at the vehicle from vehicle occupants is uniform nor is the quality of service offered by the wireless carrier system used to send the speech constant. The speech content can depend on the context of the commands given by the vehicle occupant and vary in content or length. Also, the quality of service offered by the wireless carrier system can make sending speech from the vehicle to the remote facility more or less attractive. The speech received at the vehicle can be analyzed to assess the factors related to speech content, quality of service, or both and a decision reached about whether the speech should be sent to the remote facility for recognition or whether the vehicle should carry out speech recognition processing at the vehicle.

### Communications System

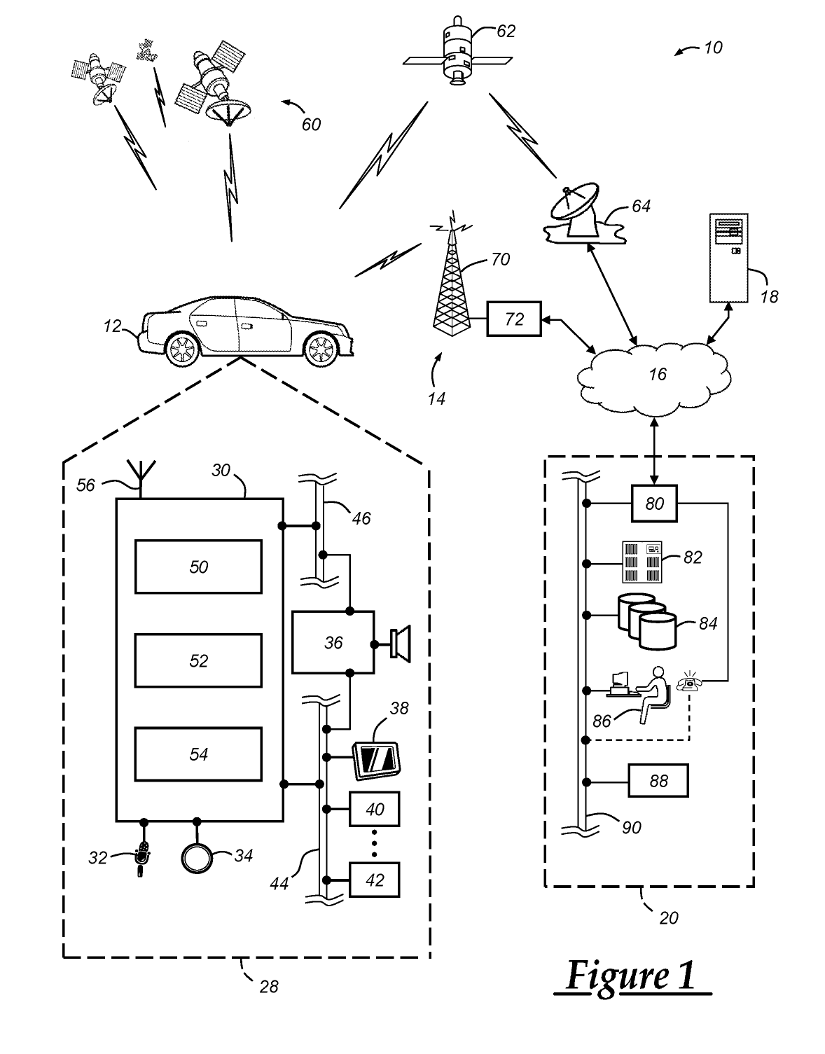

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

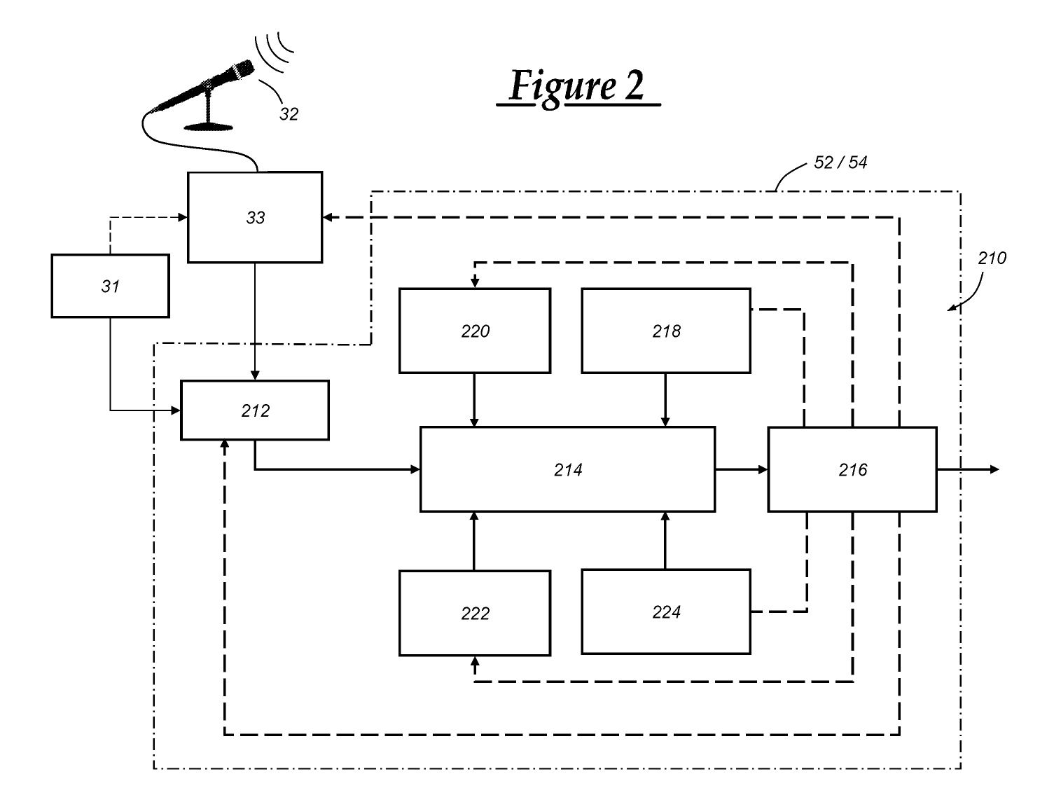

Turning now to FIG. 2, there is shown an illustrative architecture for an ASR system 210 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54 for storing the acoustic data and storing speech recognition software and databases, and a processor such as the telematics processor 52 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment in a location remote from the vehicle 12 such as the computer 18 or the call center 20. For example, grammar models, acoustic models, and the like can be stored in memory of one of the servers 82 and/or databases 84 in the call center 20 and communicated to the vehicle telematics unit 30 for in-vehicle speech processing. Similarly, speech recognition software can be processed using processors of one of the servers 82 in the call center 20. In other words, the ASR system 210 can be resident in the telematics unit 30, distributed across the computer 18/call center 20 and the vehicle 12 in any desired manner, and/or resident at the computer 18 or call center 20.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

### Method

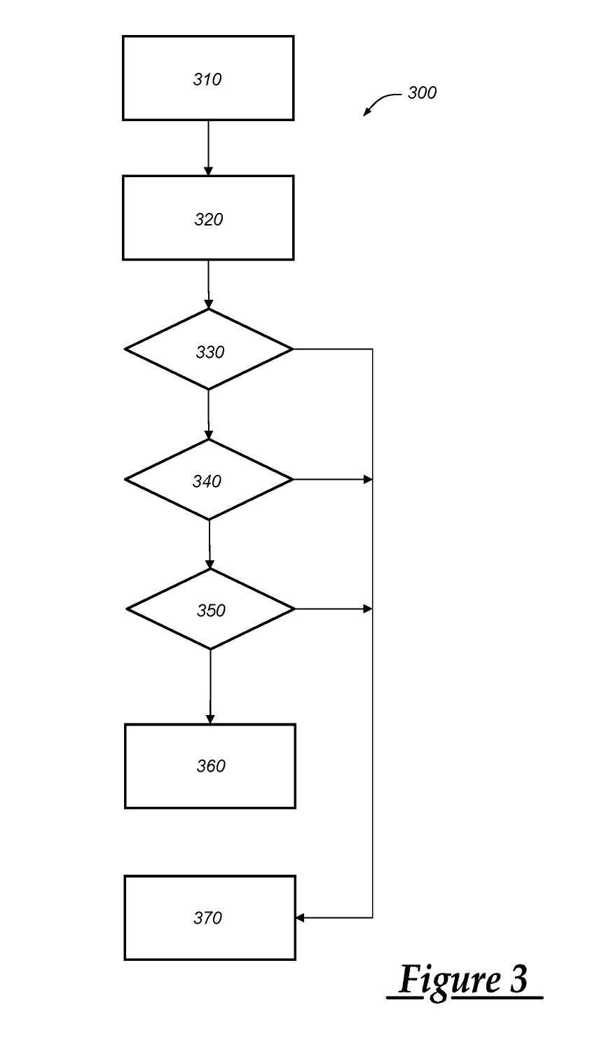

Turning now to FIG. 3, there is shown an embodiment of a method (300) of using remote speech recognition in the vehicle 12. The method 300 begins by training the ASR system 210 with a plurality of remote speech recognition command words. The ASR system 210 can include one or more grammar models 218 that have been trained using words that are commonly used to invoke speech recognition for particular contexts. These command words can be used to determine when to send received speech to a remote speech processing facility. Remote speech processing facilities are located apart from the vehicle electronics 28 of the vehicle 12; generally at a remote facility or location, such as the computer 18 or the call center 20.

It is possible to identify contexts in which speech received as part of those contexts should be sent to the remote facility. For example, in the vehicle environment, these contexts may include words relating to telephone interaction, media requests, or navigational requests. Media requests can relate to request of email, entertainment, and news content. Individual grammar models 218 can each be trained with command words that are commonly used with each context. For example, command words for a telephone context can be trained using words like “call,” “look up,” “dial,” and “contact.” With respect to requests for media, the grammar model 218 can be trained using the names of commonly accessed Internet radio applications, such as “Pandora,” “Spotify,” iHeart Radio,” and others. The grammar model 218 could also be trained with any name associated with email, entertainment, or news content (e.g., “gmail,” “ESPN,” and “New York Times,” respectively) that a vehicle occupant may request. The grammar model 218 can be trained before the vehicle 12 is delivered to a purchaser but the model 218 can also be continuously modified such that frequently-used words or commands received by the ASR system 210 can be added to the grammar model 218 through repeated use such that the ASR system 210 adapts to incorporate new commands. The method 300 proceeds to step 320.

At step 320, speech is received at the vehicle 12 from a vehicle occupant. The vehicle occupant can initiate the ASR system 210 to receive speech and commands that can control vehicle functions or request a service available at the vehicle 12. After initiating the ASR system 210 using an input, such as by depressing the button 34, the user can recite a command or a request that is received by the microphone 32 and processed as described above with respect to FIG. 2. The vehicle functions may include controlling aspects of the audio system 36, such as volume or station selection, or aspects of the climate control system, such as temperature or fan speed, to provide a few examples. Services available at the vehicle include navigational services and providing media or email content. The navigational services can involve turn-by-turn directions and information regarding a point-of-interest. Media content or email may be received at the vehicle 12 using the ability of the vehicle telematics unit 30 to access the Internet through the wireless carrier system 14. The vehicle telematics unit 30 can provide content from web-based services such as the ones identified above as well as a large number of other possible services. The method 300 proceeds to step 330.

At step 330, the received speech is initially processed using the grammar model 218, which has been trained using command words that identify context intended to be sent to the remote speech processing facility. Before arriving at a speech recognition hypothesis at the post-processor software modules 216, the ASR system 210 can process the speech using decoder module(s) 214 and the words in the grammar model 218 associated with speech context that should be sent to the remote facility. For example, a vehicle occupant may say “please access gmail and read my messages.” The ASR system 210 may not produce a speech hypothesis for the entire statement, but rather identify the words “access,” “gmail,” and/or “messages.” In another example, the vehicle occupant may provide a verbal command to access Internet content by saying “please play music from Spotify.” The ASR system 210 can identify the word “Spotify” as having a media content request, which would signal to the ASR system 210 that the speech recognition should be sent to the remote speech processing facility.

The receipt of speech as part of commands can also involve the training of a statistical language model maintained as part of the ASR system 210 that adapts to learn language provided by vehicle occupants. As new Internet applications become available and are requested by vehicle occupants, the statistical language model can recognize the frequency with which these applications are requested and build the words describing the applications into the grammar model 218. Different types of statistical language models presently exist and their implementation is understood by those skilled in the art. In some implementations, the grammar model 218 can include not only the name of the media request, such as an Internet application, but also a sub-context from which it pertains. To provide an example, the application “iHeart Radio” can be associated with the sub-context “music” or “Google Maps” can be associated with the sub-context “navigation.” The sub-context can provide additional information about the content provided by the requested application. When one or more speech recognition command words are found, the method 300 proceeds to step 370. Otherwise, the method 300 proceeds to step 360.

At step 340, the quantity of speech received from the vehicle occupant is determined. If the quantity of speech is above a particular threshold, the received speech can be processed at the vehicle 12. If the quantity of speech is below a particular threshold, the method proceeds to step 380 and can be processed at the remote speech processing facility. The ASR system 210 can measure the amount of speech received using a timer maintained by the processor 52. The ASR system 210 can determine the duration of the speech provided by the vehicle occupant and compare that duration against a time threshold. In one implementation, this time threshold can be 3.5 seconds. Speech lasting longer than 3.5 seconds can be processed by the ASR system 210 on the vehicle 12. Otherwise, speech that lasts less than 3.5 seconds can be sent to the ASR system at the remote facility. The time threshold can prevent sending longer speech segments to the remote facility thereby minimizing the amount of data sent via the wireless carrier system 14 and reducing data communications costs.

Quantity of speech can also be determined by detecting the presence of dual microphones. Speech received at more than one microphone in the vehicle 12 can significantly increase the amount of audio data to be sent over the wireless carrier system 14. When the ASR system 210 detects the presence of a plurality of microphones in the vehicle 12 or that the ASR system 210 receives speech from a plurality of microphones, the ASR system 210 can decide to process that speech at the vehicle 12 rather than sending it to the remote facility. Speech received at one microphone can be processed by the ASR system 210 at the vehicle 12. The additional data included with speech received at multiple microphones would increase the amount of data sent over the wireless carrier system 14 and increase the cost of sending that data. As a result, speech received at more than one microphone can be designated for processing at the vehicle 12 at step 360.

At step 350, a wireless quality of service between the vehicle 12 and the remote facility is determined. If the wireless quality of service is below a particular threshold, the speech is processed at the vehicle 12. If the quality of speech is above a particular threshold, the speech can be sent to the remote speech processing facility at step 380. The vehicle telematics unit 30 can send a reference signal to the remote facility that will test the quality of service available at the vehicle 12. When quality of service is low, or poor, speech recognition carried out at remote speech processing facility may not work optimally. So when these conditions exist, it can be helpful to prevent use of the remote speech processing facility to carry out speech recognition and use the ASR system 210 at the vehicle 12. The vehicle telematics unit 30 can transmit a reference signal through the cell tower 70 of the wireless carrier system 14 to the remote speech processing facility, in this implementation computer 18 or call center 20. The reference signal can be sent between the vehicle telematics unit 30 and the remote speech processing facility as part of a voice communications session. The vehicle telematics unit 30 can implement a single-ended audio quality estimation algorithm that provides a quality value representing the quality of service available at the vehicle 12. In one implementation, a P.563 algorithm described by the International Telecommunications Union (ITU) can be used to carry out the single-ended audio quality estimation. Values measured by the P.563 algorithm range from 1 (poor) to 5 (best). The ASR system 210 can calculate these values and choose to perform speech recognition at the vehicle 12 for values less than 3.5-4.0. It is also possible to use an E-model described by ITU G.107, which rates quality of service on a scale from 0-100. The ASR system 210 can decided to perform speech recognition at the vehicle 12 for values less than 65. However, it should be appreciated that other quality estimation algorithms are possible as well as different thresholds.

The vehicle telematics unit 30 can also determine the location of the vehicle 12 when sending the reference signal and use the location to determine the frequency with which the vehicle telematics unit 30 will send additional reference signals to reassess the quality of service. If the vehicle 12 has not moved or has moved only slightly over a defined period of time, the vehicle telematics unit 30 can decide not to transmit another reference signal or extend the time period between reference signal transmissions. However, if the vehicle 12 is travelling along a road, the vehicle telematics unit 30 may decide to send reference signals more frequently. For example, when the vehicle 12 is parked for a day or travelling such that the vehicle telematics unit 30 maintains communications with the same cell tower 70, the vehicle telematics unit 30 can employ an extended monitoring schedule and send reference signals once a day. On the other hand, if the vehicle telematics unit 30 is travelling such that it changes cell towers as the vehicle 12 moves, the vehicle telematics unit 30 can send reference signals more frequently, such as every twenty minutes. These time values are merely used to explain one possible implementation and it should be appreciated that other values are possible.

Quality of service can be estimated in other ways as well. The vehicle telematics unit 30 can determine the signal strength of the cell tower 70 the vehicle telematics unit 30 is communicating with or “camped on.” If the signal strength is below a particular threshold, speech recognition on the received speech can be performed at the vehicle 12 (step 360) whereas if the signal strength is above a particular threshold, the remote speech processing facility can process the speech (step 370). The ASR system 210 can send received speech to the remote speech processing facility when the signal strength of the received cell tower signal is less than −90 dB in one possible implementation.

At step 360, the received speech is processed at the vehicle 12. The speech received at the vehicle 12 can be processed using the ASR system 210 as discussed above with respect to FIG. 2.

At step 370, the received speech is wirelessly transmitted to a remote speech processing facility. The vehicle telematics unit 30 can send the received speech to the remote speech processing facility via the wireless carrier system 14. The speech can be received at the remote speech processing facility as packetized data and processed as discussed above with respect to the ASR system 210 and FIG. 2. As pointed out above, the remote speech processing facility can be the computer 18 or the call center 20. Once the remote facility produces a most-likely or list of most-likely speech recognition hypotheses, the most-likely speech hypotheses can be send from the remote speech processing facility to the vehicle telematics unit 30 as packetized data via the wireless carrier system 14. The method 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of using remote speech recognition at a vehicle, comprising the steps of:
(a) receiving speech at the vehicle from a vehicle occupant;
(b) determining a wireless quality of service between the vehicle and a remote speech processing facility;
(c) transmitting the received speech to the remote speech processing facility when the wireless quality of service is above a threshold; and
(d) processing the received speech at the vehicle when the wireless quality of service is below the threshold while preventing the transmission of the received speech to the remote speech processing facility while the wireless quality of service is determined to be below the threshold;
wherein the determinations of the wireless quality of service in steps (b) and (d) comprise transmitting a reference signal from the vehicle to the remote speech processing facility via a wireless carrier system and using single ended-ended audio quality estimation to determine a quality value representing the quality of service;
wherein step (c) comprises transmitting the received speech to the remote speech processing facility when the quality value determined by the single ended-ended audio quality estimation is above the threshold and step (d) comprises transmitting the received speech to the remote speech processing facility when the quality value determined by the single ended-ended audio quality estimation is below the threshold and
wherein the method further comprises subsequently transmitting the reference signal from the vehicle to the remote speech processing facility via the wireless carrier system to reassess the quality of service at a time dependent on a detected vehicle movement.

2. (canceled)

3. The method of claim 1, wherein the wireless quality of service is determined using a P.563 algorithm described by the International Telecommunications Union (ITU) or an E-model described by ITU G.107 as an algorithm for the single-ended audio quality estimation algorithm.

4. The method of claim 1, wherein the reference signal is periodically transmitted from the vehicle to the remote speech processing facility via the wireless carrier system.

5. The method of claim 4, wherein the periodicity of reference signal transmission varies depending on vehicle movement.

6. The method of claim 1, wherein the remote speech processing facility comprises a call center.

7. A method of using remote speech recognition at a vehicle, comprising the steps of:
(a) training an automatic speech recognition (ASR) system with a plurality of remote speech recognition command words;
(b) receiving speech at the vehicle from a vehicle occupant;
(c) initially processing the received speech using the ASR system;
(d) identifying one or more remote speech recognition command words included in the received speech before generating a speech hypothesis, wherein the command words are defined in a grammar model; and
(e) wirelessly transmitting the received speech to the remote speech processing facility based on the presence of one or more speech recognition command words previously defined in the grammar model;
wherein the ASR system further comprises a statistical language model that receives and identifies additional command words at the vehicle from more than one vehicle occupant.

8. The method of claim 7, wherein the command words refer to media requests, navigation requests, or telephone requests.

9. (canceled)

10. The method of claim 7, wherein the remote speech processing facility comprises a call center.

11. A method of using remote speech recognition at a vehicle, comprising the steps of:
(a) receiving speech at the vehicle from a vehicle occupant;
(b) determining the quantity of speech received from the vehicle occupant, wherein the quantity of speech is determined from a verbal input by the vehicle occupant;
(c) transmitting the received speech to a remote speech processing facility when the quantity of speech is below a threshold; and
(d) processing the received speech at the vehicle when the quantity of speech is above the threshold;
wherein the quantity of speech is measured based on a time threshold.

12. (canceled)

13. The method of claim 11, wherein the quantity of speech is determined based on the existence of a plurality of microphones in the vehicle.

14. The method of claim 11, wherein the remote speech processing facility comprises a call center.
